(19) United States
(12) Patent Application Publication
(10) Pub. No.: US 2006/0113896 A1
(43) Pub. Date: Jun. 1, 2006

(54) Organic electro-luminescence display device and fabricating method thereof

(75) Inventor: Dae Sick Cho, Gyeongsangbuk-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/289,465

(22) Filed: Nov. 30, 2005

(30) Foreign Application Priority Data
Dec. 1, 2004 (KR) P2004-100055

(51) Int. Cl. H05B 33/02; H05B 33/00

(52) U.S. Cl. 313/503; 313/506; 445/24

(57) ABSTRACT

There are disclosed an organic electro luminescence display device that is adaptive for preventing the damage of signal lines, and a fabricating method thereof. An organic electro luminescence display device according to an embodiment of the present invention includes an organic electro luminescence array and a substrate where signal lines are formed for transmitting a driving signal to the organic electro luminescence array; and a pattern spacer located between the substrate and a cap to prevent the contact of the cap and the signal line, wherein the cap is for packaging the organic electro luminescence array.

This application claims the benefit of the Korean Patent Application No. P2004-100055 filed on Dec. 1, 2004, which is hereby incorporated by reference.

### BACKGROUND OF THE INVENTION

1. Field of the Invention

The present invention relates to an organic electro luminescence display device, and more particularly to an organic electro luminescence display device that is adaptive for preventing the damage of signal lines, and a fabricating method thereof.

2. Description of the Related Art

Recently, there have been developed a variety of flat panel display devices that can reduce their weight and size, which are a disadvantage of a cathode ray tube CRT. The flat panel display device includes a liquid crystal display LCD, a field emission display FED, a plasma display panel PDP and an electro luminescence EL display device.

Studies for increasing the picture quality and the size of the screen of the flat panel display device have been actively in progress. The EL display device among these is a self-luminous device which emits light by itself. The EL display device excites a phosphorus material by use of a carrier such as electrons and holes, thereby displaying a video image.

The EL display device is largely divided into an inorganic EL display device and an organic EL display device in accordance with a material used.

The organic EL display device is driven with a low voltage of about 5˜20V in comparison with the inorganic EL display device which requires a high voltage of 100˜200V so that a direct low voltage driving is possible. Further, the organic EL display device has excellent characteristics such as wide viewing angle, high speed response, high contrast ratio and so on, thus the organic EL display device can be used as a pixel of a graphic display and a pixel of a surface light source or a television image display, and the organic EL display device is a suitable next generation flat panel display because of its thinness and lightness and a good color sense.

FIG. 1 is a diagram briefly representing a general organic EL display device, and FIGS. 2 and 3 are diagrams specifically representing the organic EL array formed in a display area P1 of the organic EL display device shown in FIG. 1.

The related art organic El display device shown in FIGS. 1 to 3 includes a display area P1 where there is formed an organic EL array, a non-display area P2 where there is located a pad part 25 which supplies driving signals to driving electrodes of the display area P1, and a cap 28 for packaging the display area P1.

The display area P1 has an anode electrode 4 formed on a substrate 2 and a cathode electrode 12 formed in a crossing direction to the anode electrode 4.

A plurality of anode electrodes 4 are formed on the substrate 2 to be separated from each other with a designated gap. An insulating film 6 having an aperture part is formed for each EL cell area on the substrate 2 where the anode electrode 4 is formed. Barrie ribs 8 are located on the insulating film 6 for separating an organic light emitting layer 10 and the cathode electrode 12 which are to be formed thereon. The barrier ribs 8 are formed in a direction of crossing the anode electrode 4 and have an overhang structure where an upper end part has a wider width than a lower end part. The organic light emitting layer 10 and the cathode electrode 12 formed of anorganic compound are sequentially deposited over the entire surface of the insulating film 6 where the barrier ribs 8 are formed. The organic light emitting layer 10 has a hole transport layer, a light emitting layer and an electron transport layer deposited and formed on the insulating film 6.

In the non-display area P2, there are formed a first signal line 54 which is extended from the anode electrode 4 of the display area P1, data pads which supply a data voltage to the anode electrode 4 through the first signal line 54, a second signal line 52 which is connected to the cathode electrode 12, and a scan pad which supplies a scan voltage through the second signal line 52.

The data pad is connected to a TCP, on which a first driving circuit generating a data voltage is mounted, to supply the data voltage to each anode electrode 4. The scan pad is formed on both sides of the data pad. The scan pad is connected to a TCP, on which a second driving circuit generating a scan voltage is mounted, to supply the scan voltage to each cathode electrode 12.

The cap 28 does a packaging on the display area P1 by an encapsulation process, thereby playing the role of protecting the organic EL array which is formed in the display area P1.

In the related art organic EL display device having such a structure, as shown in FIG. 4, if a voltage is applied between the anode electrode 4 and the cathode electrode 12, an electron (or cathode) generated from the cathode electrode 12 moves toward the light emitting layer 10c through the electron injection layer 10a and the electron transport layer 10b. Further, a hole (or anode) generated from the anode electrode 4 moves toward the light emitting layer 10c through the hole injection layer 10e and the hole transport layer 1d.

Accordingly, light is generated by a recombination of the electron and the hole which are supplied from the electron transport layer 10b and the hole transport layer 10b are collided and recombined in the light emitting layer 10C to generate light, and the generated light is emitted to the outside through the anode electrode 4, thereby displaying a picture.

On the other hand, the first and second signal lines 54, 52 of the related art organic EL display device are often damaged by being pressed by a ball spacer 27. In reference to FIG. 5, this is described specifically as follows.

FIG. 5 is a sectional diagram illustrating the organic EL display device, taken along the line II-II′ of FIG. 1. In reference to FIG. 5, this is explained as follows.

FIG. 5 shows a joining area of the cap 28 and the substrate 2, where the first and second signal lines 54 and 52 are located, through the sealant 25.

The sealant 25 plays the role of joining the substrate 2 and the cap 28. Herein, a plurality of ball spacers 27 are located within the sealant 25. The ball spacer 27 keeps a designated space between the signal lines 54, 52 and the cap 28, thereby playing the role of preventing the short circuit between the cap 28 and the signal lines 54, 52. Accordingly, the diameter d1 of the ball spacer 27 is the extent of keeping a designated distance, e.g., about 10 μm, between the signal lines 54, 52 and the cap 28.

The ball spacer 27 plays the role of keeping the distance between the signal lines 54, 52 and the cap 28, but give damage on the first and second signal lines 54, 52. That is, after the cap 28 is aligned with the substrate 2 through the sealant 25, in case that the cap 28 and the substrate 2 move a little for aligning, there occurs a problem in that the ball spacers 27 applies a physical impact to the first and second signal lines 54, 52 so that the first and second signal lines 54, 52 are damaged or even short-circuited.

### SUMMARY OF THE INVENTION

Accordingly, it is an object of the present invention to provide an organic electro luminescence display device that is adaptive for preventing the damage of signal lines, and a fabricating method thereof.

In order to achieve these and other objects of the invention, an organic electroluminescence display device according to an aspect of the present invention includes an organic electro luminescence array and a substrate where signal lines are formed for transmitting a driving signal to the organic electro luminescence array; and a pattern spacer located between the substrate and a cap to prevent the contact of the cap and the signal line, wherein the cap is for packaging the organic electro luminescence array.

In the organic electro luminescence display device, the pattern spacer is located between the signal lines.

In the organic electro luminescence display device, the organic electro luminescence array includes an anode electrode formed on the substrate; an insulating film which defines a light emitting area on the anode electrode; a barrier rib formed to cross the anode electrode; an organic light emitting layer formed on the light emitting area; and a cathode electrode to cross the anode electrode with the organic light emitting layer therebetween, and wherein the pattern spacer is formed of the same material as at least any one of the insulating film and the barrier rib at the same time.

In the organic electro luminescence display device, the height of the pattern spacer is about 4˜10 mm.

A fabricating method of an organic electro luminescence display device according to another aspect of the present invention includes the steps of forming an organic electro luminescence array and signal lines on a substrate, wherein the signal lines are for transmitting a driving signal to the organic electro luminescence array; and forming a pattern spacer located between the substrate and a cap to prevent the contact between the signal lines, wherein the cap is for packaging the organic electro luminescence array.

In the fabricating method, the pattern spacer is located between the signal lines.

In the fabricating method, the step of forming the organic electro luminescence array includes forming the organic electro luminescence array; forming an anode electrode on the substrate; forming an insulating film which defines a light emitting area on the anode electrode; forming a barrier rib to cross the anode electrode; forming an organic light emitting layer on the light emitting area; and forming a cathode electrode to cross the anode electrode with the organic light emitting layer therebetween, and wherein the pattern spacer is formed of the same material as at least any one of the insulating film and the barrier rib at the same time.

In the fabricating method, the height of the pattern spacer is about 4˜10 μm.

### BRIEF DESCRIPTION OF THE DRAWINGS

These and other objects of the invention will be apparent from the following detailed description of the embodiments of the present invention with reference to the accompanying drawings, in which:

FIG. 1 a plane view briefly illustrating a related art organic electro luminescence display device;

FIGS. 2 and 3 are a perspective view and a sectional diagram specifically illustrating a display area of the organic electro luminescence display device shown in FIG. 1;

FIG. 4 is a diagram for explaining an light emitting principle of the related art organic electro luminescence display device;

FIG. 5 is a diagram for explaining that the signal line of the related art organic electro luminescence display device is damaged by the ball spacer of the sealant;

FIG. 6 is a sectional diagram specifically illustrating an area of an organic electro luminescence display device according to the embodiment of the present invention;

FIG. 7 is a diagram representing another shape of a pattern spacer of the present invention;

FIGS. 8A to 8H are diagrams for explaining a fabricating method of an organic electro luminescence display device according to an embodiment of the present invention; and

FIG. 9 is a diagram representing that a pattern spacer is formed of the same material as a barrier rib at the same time.

### DETAILED DESCRIPTION OF THE PREFERRED EMBODIMENT

Reference will now be made in detail to the preferred embodiments of the present invention, examples of which are illustrated in the accompanying drawings.

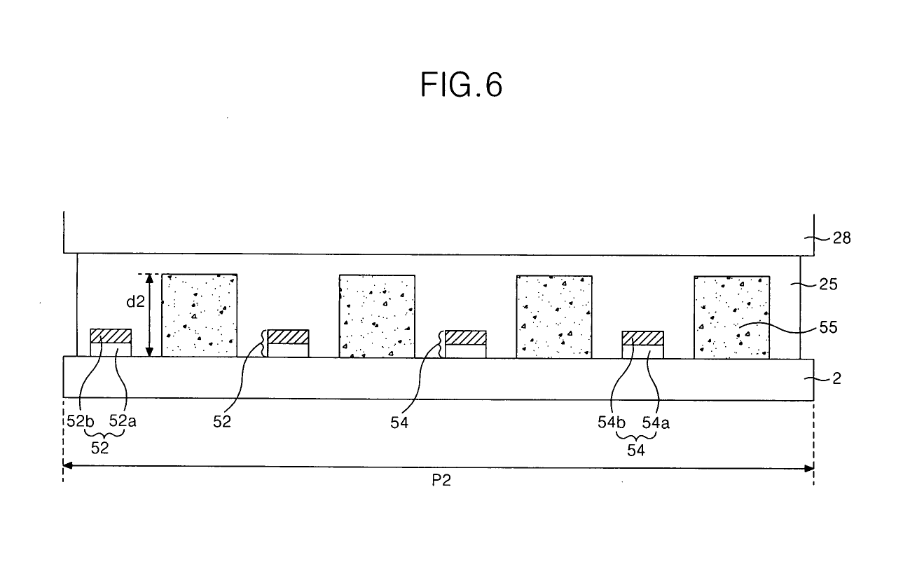

With reference to FIGS. 6 to 9, embodiments of the present invention will be explained as follows.

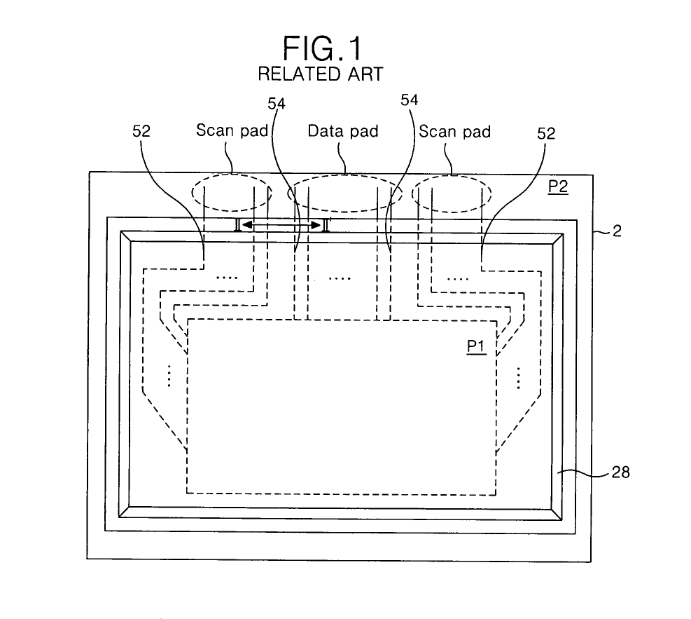

An organic EL display device according to the present invention, as in FIG. 1 of the related art, includes a display area P1 where there is formed an organic EL array, a non-display area P2 where there is located a pad part 25 which supplies driving signals to driving electrodes of the display area P1, and a cap 28 for packaging the display area P1.

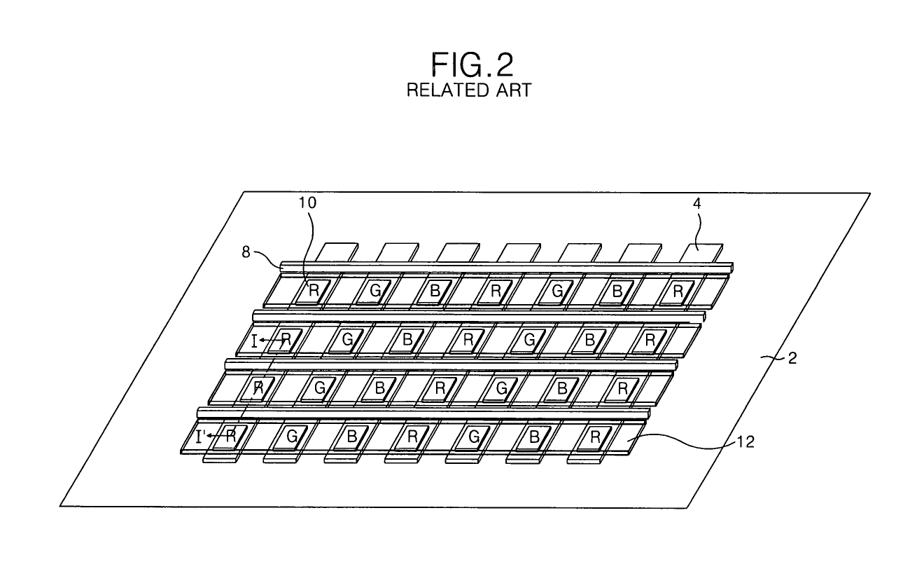

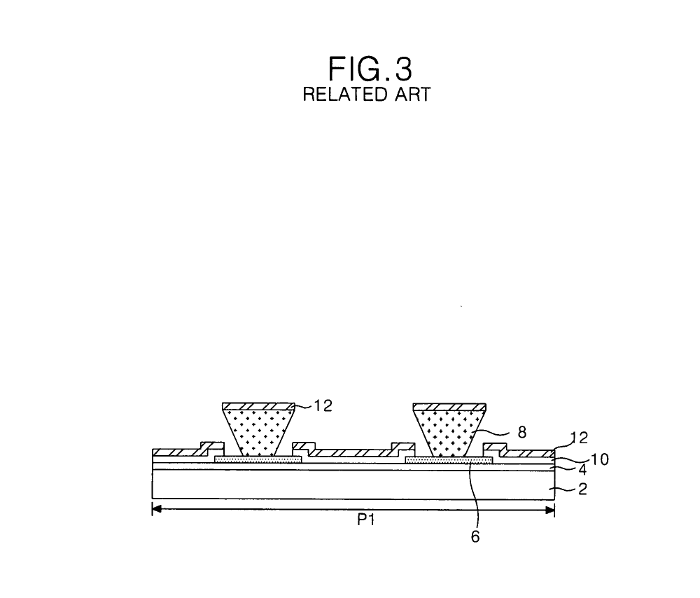

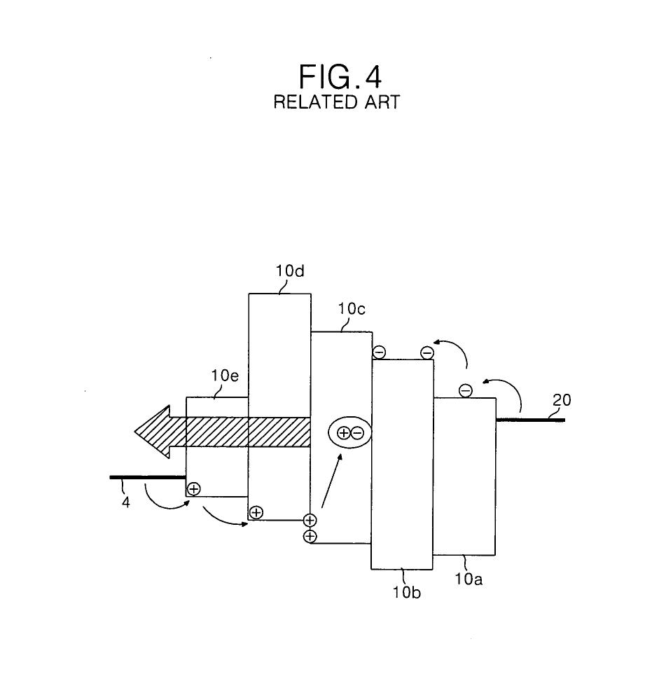

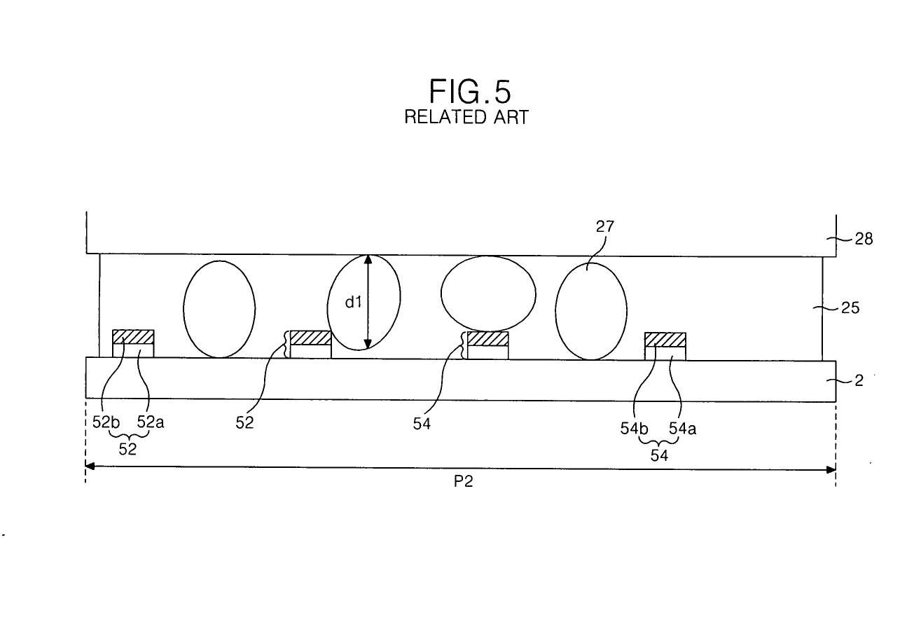

The display area P1, as in FIG. 2 of the related art, has an anode electrode 4 formed on a substrate 2 and a cathode electrode 12 formed in a crossing direction to the anode electrode 4.

A plurality of anode electrodes 4 are formed on the substrate 2 to be separated from each other with a designated gap. An insulating film 6 having an aperture part is formed for each EL cell area on the substrate 2 where the anode electrode 4 is formed. Barrie ribs 8 are located on the insulating film 6 for separating an organic light emitting layer 10 and the cathode electrode 12 which are to be formed thereon. The barrier ribs 8 are formed in a direction of crossing the anode electrode 4 and have an overhang structure where an upper end part has a wider width than a lower end part. The organic light emitting layer 10 and the cathode electrode 12 formed of an organic compound are sequentially deposited over the entire surface of the insulating film 6 where the barrier ribs 8 are formed. The organic light emitting layer 10 has a hole transport layer, a light emitting layer and an electron transport layer deposited and formed on the insulating film 6.

In the non-display area P2, there are formed a first signal line 54 which is extended from the anode electrode 4 of the display area P1, data pads which supply a data voltage to the anode electrode 4 through the first signal line 54, a second signal line 52 which is connected to the cathode electrode 12, and a scan pad which supplies a scan voltage through the second signal line 52.

The data pad is connected to a TCP, on which a first driving circuit generating a data voltage is mounted, to supply the data voltage to each anode electrode 4. The scan pad is formed on both sides of the data pad. The scan pad is connected to a TCP, on which a second driving circuit generating a scan voltage is mounted, to supply the scan voltage to each cathode electrode 12.

The cap 28 does a packaging on the display area P1 by an encapsulation process, thereby playing the role of protecting the organic EL array which is formed in the display area P1.

FIG. 6 is a diagram representing an area of an organic electro luminescence display device according to an embodiment of the present invention, i.e., a joining area of the cap 28 and the substrate 2 where the first and second signal lines 54, 52 are formed.

The first and second signal lines 54, 52 are located on the substrate 2, and a pattern spacer 55 is formed to have a designated height between the signal lines 54, 52 for preventing the contact between the cap 28 and the signal lines 54, 52. The cap 28 is bonded through the sealant 25 with the substrate 2 where the pattern spacer 55 is formed. Herein, there exists no ball spacer 27 the sealant 25 in the sealant 25 differently from the related art.

The pattern spacer 55 is patterned without fluidity differently from the ball spacer 27 within the sealant 25 of the related art to be fixed on the substrate 2, thus damaging the signal lines 54, 52 is made not to be generated even though the cap 28 and the substrate 2 move a little when aligning the cap 28 and the substrate 2. That is, the pattern spacer 55 of the present invention might be able to prevent the contact of the signal lines 54, 52 and the cap 28 while preventing the damage of the signal lines 54, 52.

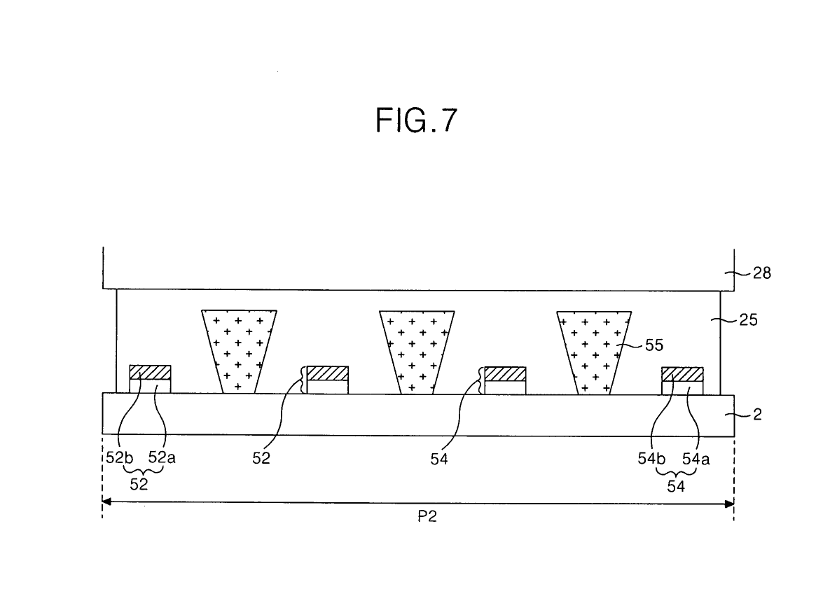

Herein, the pattern spacer 55 might be formed of an insulating material or formed of the same material as the barrier rib 8 of the organic EL array at the same time, as shown in FIG. 7. Further, the pattern spacer 55 is formed to have a height of about 4˜10 μm in order to prevent the contact of the signal lines 54, 52 and the cap 28.

In this way, the organic EL display device according to the present invention forms the pattern spacer 55 which has a designated height between the signal lines 54, 52, and the substrate 2 and the cap 28 are joined by use of the sealant 25 that does not have the ball spacer 27. Accordingly, the damage of the signal lines 54, 52 is prevented.

On the other hand, in the present invention, the pattern spacer 55 can be formed in the entire area where the substrate 2 and the cap 28 are joined as well as between the signal lines 54, 52.

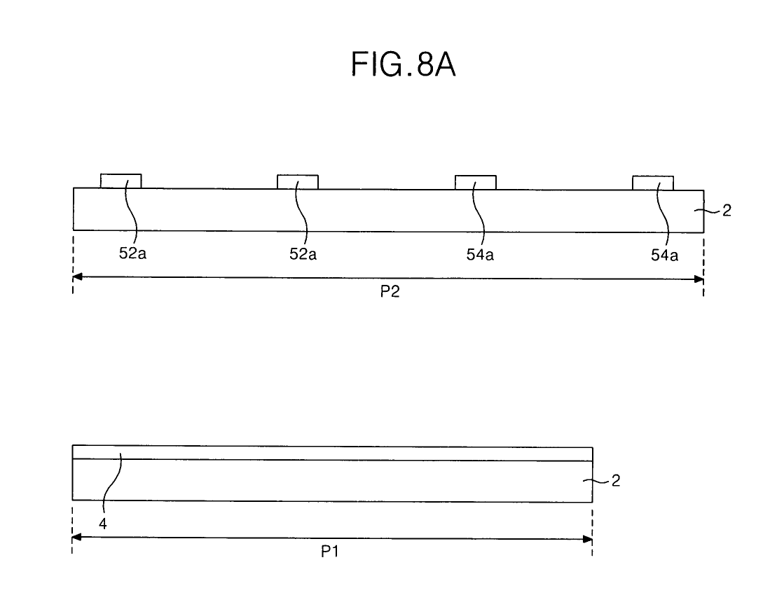

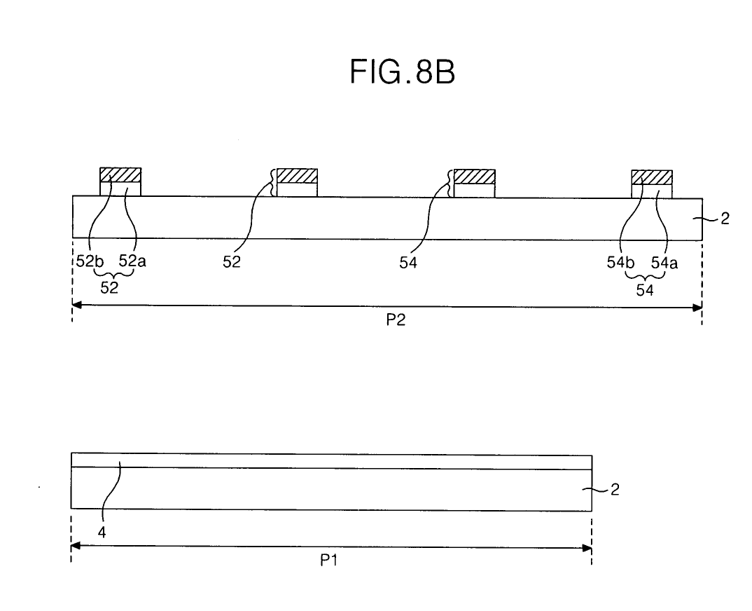

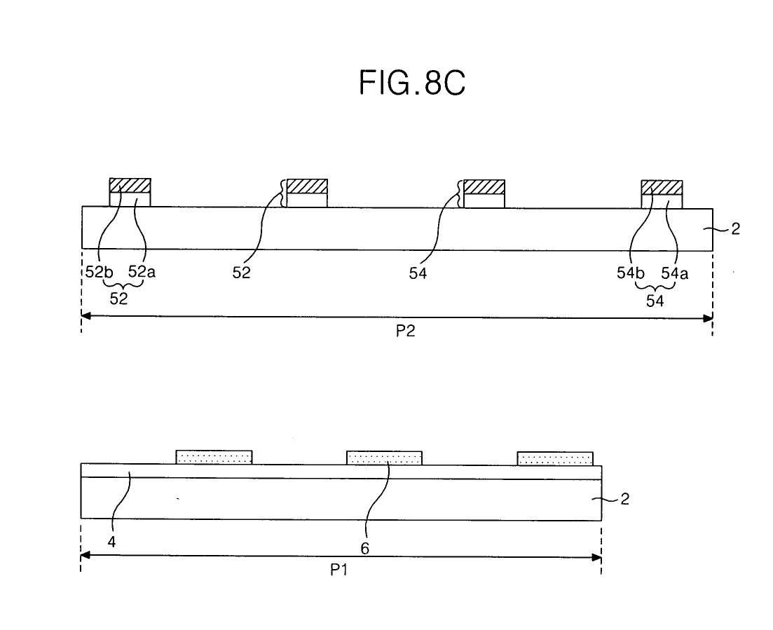

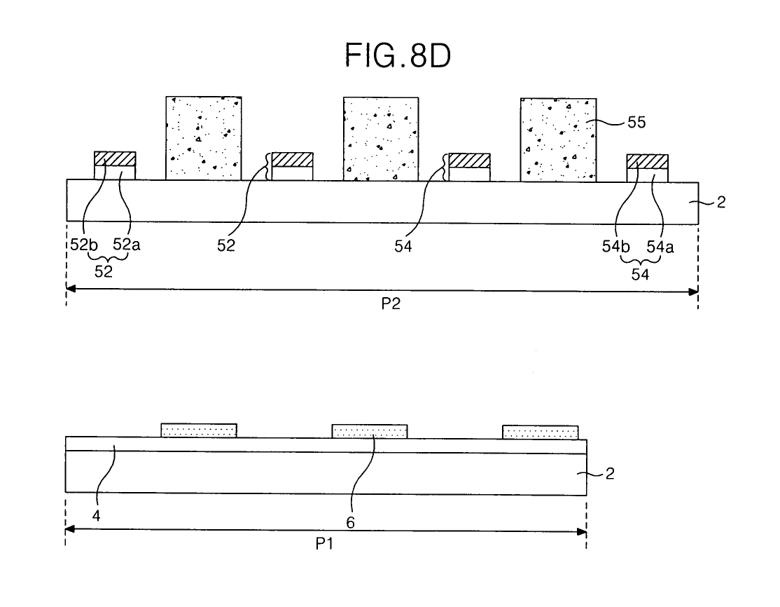

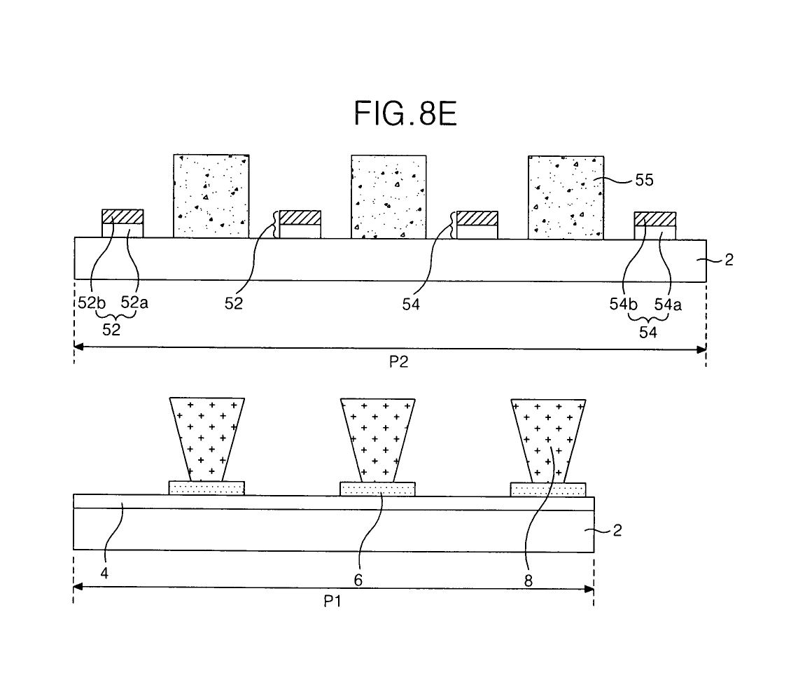

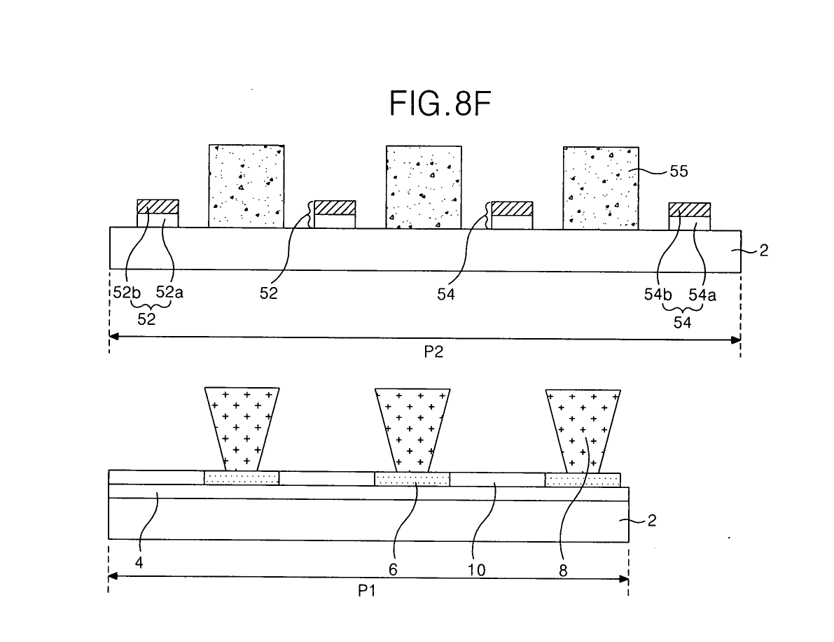

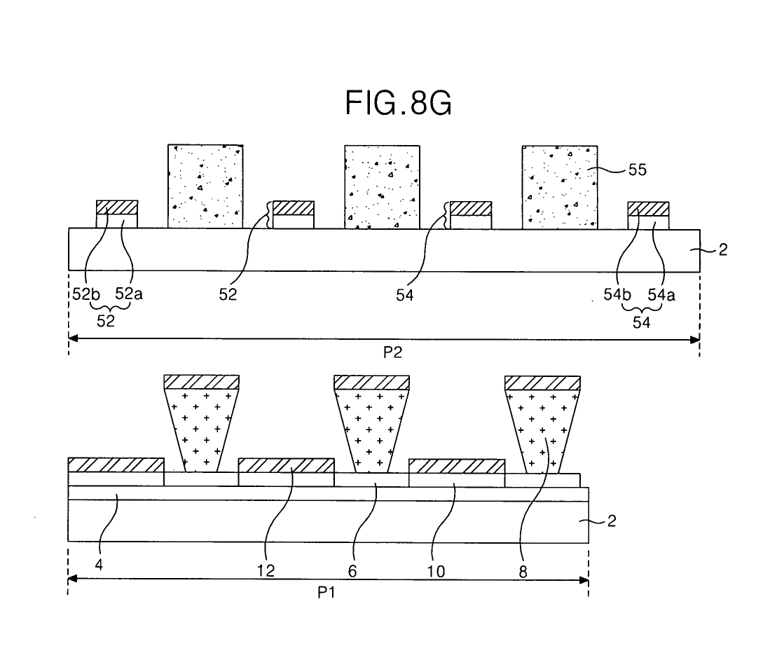

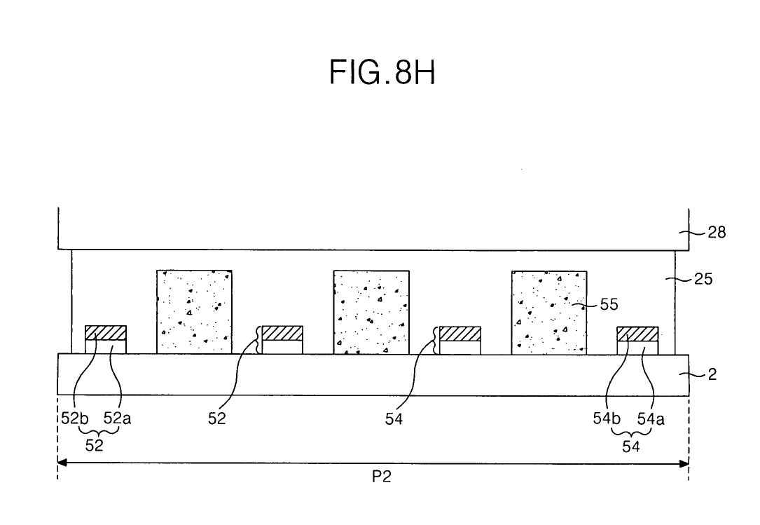

FIGS. 8A to 8H are diagrams for explaining a fabricating method of an organic EL display device according to an embodiment of the present invention.

Firstly, after depositing a transparent conductive material on the substrate 2 which is formed by use of sodalime or hard glass, the transparent conductive material is patterned by a photolithography process and an etching process, thereby forming the anode electrode 4 of the display area P1 and first and second transparent conductive lines 54A, 52A in the non-display area P2, as shown in FIG. 8A. Herein, the transparent conductive material is indium tin oxide or SnO2.

After an opaque conductive material is deposited on the substrate 2 where the anode electrode 4, first and second transparent conductive lines 54A, 52A, the opaque conductive material is patterned by a photolithography process and an etching process, thereby forming a first opaque conductive line 54B on the first transparent conductive line 54A and forming a second opaque conductive line 52B on the second transparent conductive line 52A, as shown in FIG. 8B. Accordingly, the first and second signal lines 54, 52 are formed. On the other hand, the first signal line 54 connected to the anode electrode 4 can be formed only of the transparent conductive line.

After a photo sensitive insulating material such as polyimide is coated by a spin coating method on the substrate 2 where the anode electrode 4 is formed, the photo sensitive insulating material is patterned by the photolithography process, thereby forming an insulating film 6 to exposes the light emitting area, as shown in FIG. 8C.

After an insulating material is formed on the substrate 2 where the first and second signal lines 54, 52 and the insulating film 6 are formed, the insulating material is patterned by the photolithography process, thereby forming the pattern spacer 55 between the signal lines 54, 52, as shown in FIG. 8D.

Herein, the pattern spacer 55 can be formed of the same material as the insulating material 6 without a separate process at the same time.

After a photo sensitive organic material is deposited on the substrate 102 where the insulating film 6 and the pattern spacer 55 are formed, the photo sensitive organic material is patterned by the photolithography process, thereby forming the barrier rib 8, as shown in FIG. 8E.

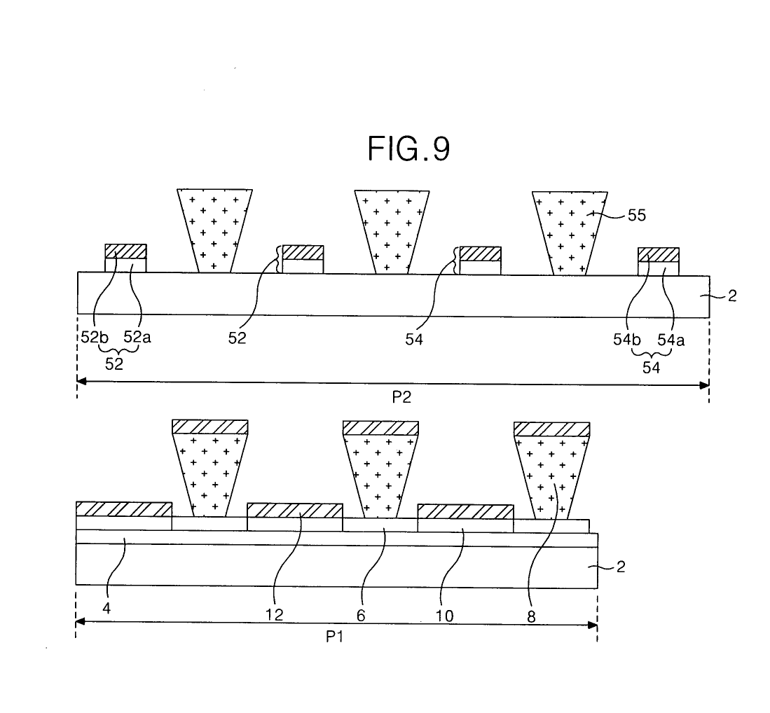

Herein, the pattern spacer 55 can be formed of the same material as the barrier rib 8 at the same time, as shown in FIG. 9. Herein, the height of the pattern spacer 55 is about 4˜10 μm.

The organic light emitting layer 10 is formed by a thermal deposition method and a vacuum deposition method by use of a common mask and a shadow mask (not shown) on the substrate 2 where the barrier rib 8 is formed.

A metal material is deposited on the substrate 2 where the organic light emitting layer 10 is formed, thereby forming the cathode electrode 12, as shown in FIG. 8G.

After then, an encapsulation process is performed to have the organic EL array of the display area P1 packaged by the cap 28. Herein, the cap 28 is joined with the substrate 2 through the sealant 25 in which the ball spacer 27 is removed, thereby completing the organic EL display device.

As described above, in the organic EL display device and the fabricating method thereof according to the present invention, there is formed the pattern spacer which is located between the signal lines and has a designated height. Accordingly, the ball spacer can be removed from the sealant, thereby preventing the damage of the signal line which is caused by the ball spacer.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. An organic electro luminescence display device, comprising:
an organic electro luminescence array and a substrate where signal lines are formed for transmitting a driving signal to the organic electro luminescence array; and
a pattern spacer located between the substrate and a cap to prevent the contact of the cap and the signal line, wherein the cap is for packaging the organic electro luminescence array.

2. The organic electro luminescence display device according to claim 1, wherein the pattern spacer is located between the signal lines.

3. The organic electro luminescence display device according to claim 1, wherein the organic electroluminescence array includes:
an anode electrode formed on the substrate;
an insulating film which defines a light emitting area on the anode electrode;
a barrier rib formed to cross the anode electrode;
an organic light emitting layer formed on the light emitting area; and
a cathode electrode to cross the anode electrode with the organic light emitting layer therebetween, and
wherein the pattern spacer is formed of the same material as at least any one of the insulating film and the barrier rib at the same time.

4. The organic electro luminescence display device according to claim 1, wherein the height of the pattern spacer is about 4˜10 μm.

5. A fabricating method of an organic electro luminescence display device, comprising the steps of:
forming an organic electro luminescence array and signal lines on a substrate, wherein the signal lines are for transmitting a driving signal to the organic electro luminescence array; and
forming a pattern spacer located between the substrate and a cap to prevent the contact between the signal lines, wherein the cap is for packaging the organic electro luminescence array.

6. The fabricating method according to claim 5, wherein the pattern spacer is located between the signal lines.

7. The fabricating method according to claim 5, wherein the step of forming the organic electro luminescence array includes the steps of:
forming the organic electro luminescence array;
forming an anode electrode on the substrate;
forming an insulating film which defines a light emitting area on the anode electrode;
forming a barrier rib to cross the anode electrode;
forming an organic light emitting layer on the light emitting area; and
forming a cathode electrode to cross the anode electrode with the organic light emitting layer therebetween, and
wherein the pattern spacer is formed of the same material as at least any one of the insulating film and the barrier rib at the same time.

8. The fabricating method according to claim 5, wherein the height of the pattern spacer is about 4˜10 μm.
